(19) United States
(12) Patent Application Publication
(10) Pub. No.: US 2006/0132630 A1
(43) Pub. Date: Jun. 22, 2006

(54) Image sensing device with wide dynamic range and image pickup apparatus using the same

(75) Inventors: Soo-young Kim, Suwon-si (KR); Moon-cheol Kim, Suwon-si (KR); Dong-hwan Kim, Goyang-si (KR); Dong-bum Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/273,015

(22) Filed: Nov. 15, 2005

(30) Foreign Application Priority Data
Dec. 21, 2004 (KR) 2004-109165

(51) Int. Cl. H04N 5/335; H04N 3/14

(52) U.S. Cl. 348/294

(57) ABSTRACT

An image sensing device with a wide dynamic range by using an optical limiter, and an image pickup apparatus using the same. The image sensing device includes an optical limiter for converting an input image into a non-linear image at an intensity greater than a threshold intensity, and an image sensor for converting the non-linear input image into an electrical signal. By forming the optical limiter capable of outputting a non-linear image with respect to the intensity of light on the image pickup surface of the image sensor, the dynamic range of the image sensing device can be expanded without using a separate device.

### CROSS-REFERENCE TO RELATED APPLICATIONS

This application claims priority Korean Patent Application No. 2004-109165, filed on Dec. 21, 2005, the entire content of which is incorporated herein by reference.

### BACKGROUND OF THE INVENTION

1. Technical Field

The present invention relates to an image sensing device with a wide dynamic range using a non-linear optical limiter and an image pickup apparatus using the same.

2. Related Art

Dynamic range is one of determining factors of the performance of an image sensor, and indicates the ratio between the smallest and largest possible values of changeable quantity (e.g., the intensity range of the optical signal to be processed into an image). In particular, the dynamic range (DR) of an image sensing device is defined as the ratio of the saturation level (i.e., the effective maximum detectable signal level) with respect to noise level of the pixel. This is shown in Equation 1.

$$D = 20 {log}_{10} ( \frac{Saturation \text{-} level}{Noise} ) \qquad [ Equation 1 ]$$

where ‘D’ denotes the dynamic range of an image sensor; ‘Noise’ denotes a signal noise; and ‘Saturation-level’ denotes the saturation level of a pixel.

For example, if an image sensor senses about 200,000 electrons when saturated, and about 40 electrons when noise exists, then the dynamic range of the image sensor is approximately 5,000, and dB is approximately −75 dB.

Meanwhile, if a dark area and a bright area are mixed on a screen, each area is usually distinguished by adjusting exposure time for an input light. However, since adjusting the exposure time is not sufficient for distinguishing all of the areas, it is necessary to expand the dynamic range of an image sensor.

There are several examples for expanding the dynamic range of an image sensor, including outputting saturation time, differentiating the exposure time by pixels, and outputting the rate of increase of a signal charge.

In the related art, the method for outputting saturation time involves outputting the exposure time, not but reading the charge or voltage of a pixel. More specifically, the arrival time for an output signal of a light receiving element at a threshold voltage designating the potential of a photodiode of the image sensor punctually, or the time immediately before the arrival is outputted through a counter using a comparator circuit instead of an A/D converter (Analog to Digital Converter). In other words, the comparator circuit, not the A/D converter, checks the time at which the output signal reaches the threshold voltage, and digitally converts the discrete value of the stored charges. These processes are realized only through the comparator circuit.

On the other hand, the method for differentiating the exposure time by pixels has been widely used for maintaining a signal level and realizing a wide dynamic range by shortening the exposure time for a pixel to which light of strong intensity is irradiated, while extending the exposure time for a pixel to which light of weak intensity (e.g., a dark video signal) is irradiated. Despite these merits, the method is not preferred because it requires an additional circuit for adjusting the exposure time based on the pixels.

### SUMMARY OF THE INVENTION

The present invention to provides an image sensing device with a wide dynamic range, capable of making an input image to an image sensor be non-linear with respect to the intensity of light by means of an optical limiter, and an image pickup apparatus using the same.

According to an aspect of the present invention, there is provided an image sensing device, including: an optical limiter for converting an input image into a non-linear image at an intensity greater than a threshold intensity; and an image sensor for converting the non-linear input image into an electrical signal.

The image sensor includes: a micro lens for condensing an input light; a color filter for extracting a specific color signal out of signals inputted from the micro lens; and a substrate for converting the extracted color signal into an electrical signal.

The optical limiter is formed at a threshold distance away from an image pickup surface of the image sensor.

In another exemplary embodiment, the optical limiter is deposited on an upper portion of the image pickup surface of the image sensor.

The image sensor is either a CCD (Charge Coupled Device) or a CMOS (Complementary Metal Oxide Semiconductor).

In an exemplary embodiment, the threshold intensity is smaller than an intensity having a saturated output value of the image sensor without using the optical limiter.

Another aspect of the present invention provides an image pickup apparatus using an image sensing device with a wide dynamic range, the apparatus including: an optical limiter for converting and outputting an input image into a non-linear image at an intensity greater than a threshold intensity; an image sensor for photoelectrically converting the output image from the optical limiter; a converter for converting and outputting the image from the image sensor into a digital signal; and a signal processor performs signal processing necessary for displaying the input image from the converter.

The image sensor includes: a micro lens for condensing an input light; a color filter for extracting a specific color signal out of signals inputted from the micro lens; and a substrate for converting the extracted color signal into an electrical signal.

The optical limiter is formed at a threshold distance away from an image pickup surface of the image sensor.

In another exemplary embodiment, the optical limiter is deposited on an upper portion of the image pickup surface of the image sensor.

The image sensor is either a CCD (Charge Coupled Device) or a CMOS (Complementary Metal Oxide Semiconductor).

In an exemplary embodiment, the threshold intensity is smaller than an intensity having a saturated output value of the image sensor without using the optical limiter.

### BRIEF DESCRIPTION OF THE DRAWINGS

The above and/or other aspects of the present invention will be more apparent by describing certain exemplary embodiments with reference to the accompanying drawings, in which:

FIG. 1 illustrates an image sensing device with a wide dynamic range according to an exemplary embodiment;

FIG. 2A and FIG. 2B illustrate, respectively, an image sensing device with a wide dynamic range according to another exemplary embodiment;

FIG. 3 is a schematic block diagram of an image pickup apparatus using an image sensing device with a wide dynamic range according to an exemplary embodiment; and

FIG. 4 is a diagram for explaining the dynamic range expansion of an image sensing device according to yet another exemplary embodiment.

### DETAILED DESCRIPTION OF THE EXEMPLARY EMBODIMENTS OF THE INVENTION

Exemplary embodiments will be described herein below with reference to the accompanying drawings.

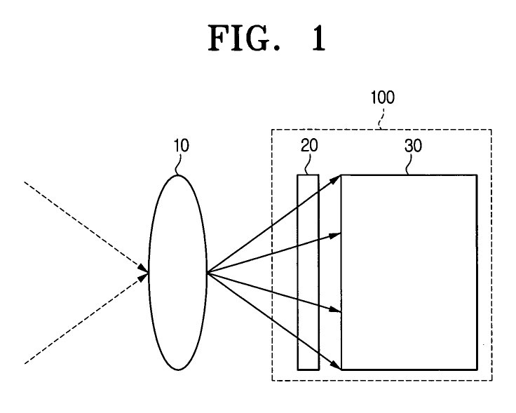

FIG. 1 is an image sensing device with a wide dynamic range according to an exemplary embodiment of the present invention. The image sensing device 100 with a wide dynamic range includes an optical limiter 20 and an image sensor 30.

The optical limiter 20 converts an input image that has been transmitted through a lens 10 to a non-linear image with respect to the intensity of a light, and outputs the converted image to the image sensor 30. The optical limiter 20 is installed at a threshold distance away from the image pickup surface of the image sensor 30. As can be seen in FIG. 1, the threshold distance is a distance for every input image that has been transmitted through the lens 10 to be inputted to the image sensor 30 via the optical limiter 20. If the optical limiter 20 is installed above a threshold distance away from the image pickup surface of the image sensor 30, part of the image passing through the optical limiter 20 is scattered and is not inputted to the image sensor 30, resulting in a loss of the image.

As the optical limiter 20 outputs a non-linear image with respect to the intensity of a light, the image sensor 30 (where the output image from the optical limiter 20 enters also outputs a non-linear image). In other words, the optical limiter 20 gives the image sensor 30 linear characteristics for the intensity, so that images having a greater intensity than a threshold intensity can be outputted as clear images with the substantially same brightness. In this manner, deterioration of resolution can be substantially prevented. In summary, the optical limiter 20 expands the band of input intensity for the saturation of the output brightness.

Upon receiving a non-linear image from the optical limiter 20, the image sensor 30 converts the input image into an electric signal. The image sensor 30 includes a micro lens, a color filter, and a substrate.

The micro lens improves the optical efficiency by condensing an input light for receiving an optical signal that is inputted in a non-pixellated area into a pixel. The color filter extracts a specific color signal among many input signals from the micro lens. Lastly, the substrate is formed of a photodiode and a transfer electrode, for photoelectrically converting an input signal from the color filter into an electric signal, and transferring the signal to the outside.

Examples of the image sensor 30 include a CCD (Charge Coupled Device) image sensor for transferring electrons generated by an input light to the output unit using a gate pulse, and a CMOS image sensor for converting electrons generated by an input light into a voltage within each pixel and outputting the voltage through a plurality of CMOS (Complementary Metal Oxide Semiconductor) switches.

Moreover, the image sensor 30 accumulates charges based on intensities of lights, and outputs a voltage corresponding to the quantity of accumulated charge, thereby determining the brightness of an image. However, because the image sensor 30 cannot accumulate charges with higher intensities than a threshold intensity, the same brightness is given to an image for those intensities higher than the threshold intensity.

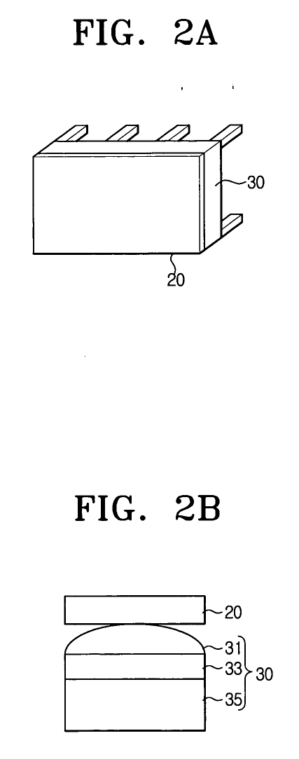

FIGS. 2A and 2B illustrate an image sensing device 100 with a wide dynamic range according to another exemplary embodiment of the present invention. The image sensing device 100 in this embodiment is different from FIG. 1 in that an optical limiter 20 is deposited on the image pickup surface of an image sensor 30.

Referring to FIGS. 2A and 2B, the image sensing device 10 includes an image sensor 30 and an optical limiter 20 formed on the image pickup surface of the image sensor 30. The image sensor 30 includes a micro lens 31, a color filter 33, and a substrate 35.

FIGS. 2A and 2B are perspective and cross-sectional views, in which a glass is not formed on the upper portion of the image pickup surface of the image sensing device 100. However, the glass can optionally be formed on the upper portion of the optical limiter 20, such that the optical limiter 20 is formed between the image sensor 30 and the glass. In this case, the glass is formed in the pixel unit for increasing the optical efficiency of the image sensing device 100.

The functions of the micro lens 31, the color filter 33 and the substrate 35 of the image sensor 30 are substantially the same as those in FIG. 1. More specifically, the micro lens 31 improves the optical efficiency by condensing an input light for receiving an optical signal that is inputted in a non-pixellated area into a pixel. The color filter 33 extracts a specific color signal among many input signals from the micro lens. Lastly, the substrate 35 is formed of a photodiode and a transfer electrode, for photoelectrically converting an input signal from the color filter 33 into an electric signal, and transferring the signal to the outside.

In the foregoing embodiment, the optical limiter 20 is formed on the upper portion of the micro lens 31 of the image sensor 30 by coating. However, the present invention is not limited thereto.

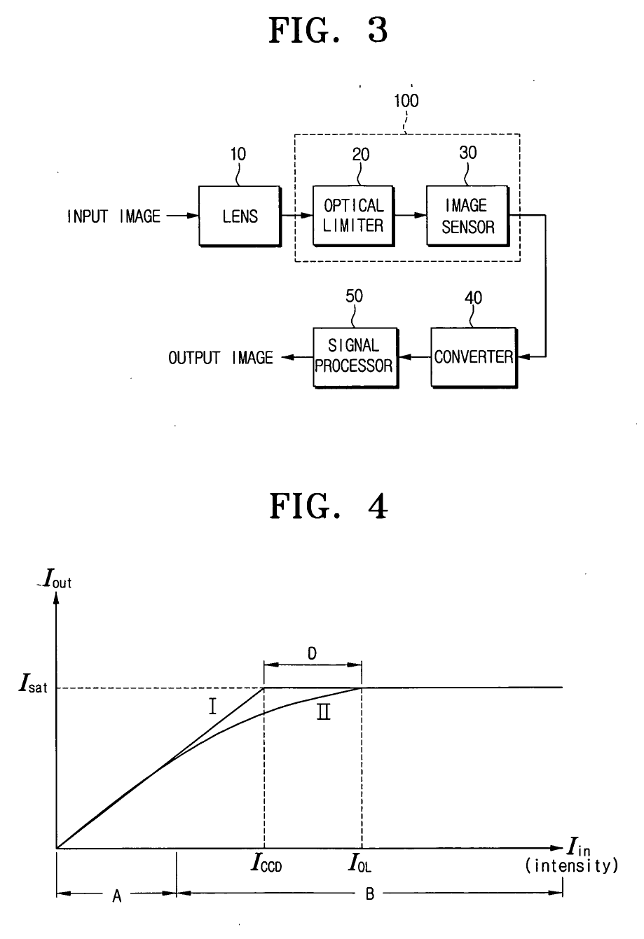

FIG. 3 is a schematic block diagram of an image pickup apparatus using an image sensing device with a wide dynamic range according to an exemplary embodiment.

Referring to FIG. 3, the image pickup apparatus includes a lens 10, an optical limiter 20, an image sensor 30, a converter 40, and a signal processor 50. Here, the optical limiter 20 and the image sensor 30 constitute an image sensing device 100.

The lens 10 condenses an input light and outputs the light to the optical limiter 20.

Through the optical limiter 20, an input image from the lens 10 is then converted into a non-linear image with respect to the intensity of the light. As a result, the image sensor 30 to which the image from the optical limiter 20 is inputted outputs a value that shows a non-linear characteristic to the intensity of the light.

The optical limiter 20 is formed on the upper portion of the image pickup surface of the image sensor 30. More specifically, the optical limiter 20 is either deposited on the image pickup surface of the image sensor 30 or formed at a threshold distance from the image pickup surface of the image sensor 30. The threshold distance is a distance for every input image transmitted through the lens 10 to be inputted to the image sensor 30 via the optical limiter 20. If the optical limiter 20 is installed above a threshold distance from the image pickup surface of the image sensor 30, part of the image passing through the optical limiter 20 is scattered and is not inputted to the image sensor 30, resulting in a loss of the image.

The image sensor 30 converts the input image from the optical limiter 20 into an electrical signal. More specifically, the image sensor 30 senses a signal charge generated in proportion to the intensity of an input light to the image sensor 30 as an analog voltage. Since the image sensor 30 has a linear characteristic, the input image to the image sensor 30 is outputted to the optical limiter 20 as a non-linear image with respect to the intensity of the input light.

An output value from the image sensor 30 has a non-linear characteristic with respect to a higher intensity than a threshold intensity. In other words, similar to the case where the optical limiter 20 is not formed on the upper portion of the image pickup surface of the image sensor 30, if the intensity of the input light is below the threshold intensity, the output value of the image sensor 30 has a linear characteristic with respect to the intensity of the input light. At this time, the threshold intensity is lower than the input intensity having a saturated output value when the optical limiter 20 is not formed on the upper portion of the image pickup surface of the image sensor 30.

When the optical limiter is not used, the output value of the image sensor 30 has a non-linear characteristic with a starting intensity that is lower than the input intensity having the saturated output value. Thus, the input intensity having a saturated output value if the optical limiter 20 is utilized is greater than the input intensity having a saturated output value if the optical limiter 20 is not utilized.

As discussed above with reference to FIG. 1 and FIGS. 2A to 2C, the image sensor 30 includes the micro sensor 31, the color filter 33 and the substrate 35.

The converter 40 converts an electrical signal inputted from the image sensor 30 into a digital signal. That is, the converter 40 is an A/D converter (Analog to Digital Converter).

The signal processor 50 performs signal processing necessary for displaying an input image from the converter 40.

FIG. 4 graphically explains the expansion of a dynamic range of the image sensing device 100 according to an exemplary embodiment. In FIG. 4, the X-axis denotes the intensities of input light (i.e., the input intensities) to the image sensing device 100, and Y-axis denotes output values of the image sensor 30. Also, graph ‘I’ shows output values of the image sensor 30 when the optical limiter 20 is not used, whereas graph ‘II’ shows output values of the image sensor 30 when the optical limiter 20 is used.

In the graph, Iₛₐₜ is a saturated output value of the image sensor 30; I_{CCD} is a minimum intensity among intensities having a saturated output value when the optical limiter 20 is not used; and I_{OL} is a value of the intensity having a saturated output value when the optical limiter 20 is used.

The interval A illustrates where the output values of the image sensor 30 reflected on the graph I have a linear characteristic, and the interval B illustrates where the output values of the image sensor 30 reflected on the graph I have a non-linear characteristic. The interval D shows non-linear output values of the image sensor 30 when the optical limiter 30 is used. In that case, the dynamic range of the image sensor 30 is expanded.

In detail, in case of the graph I where the optical limiter 20 is not used, the output values of the image sensor 30 are linear until reaching the intensity I_{CCD} having a saturated output value, but they remain constant (i.e., the same saturated output value) at the intensities greater than I_{CCD}.

On the other hand, in case of the graph II where the optical limiter 20 is used, the output values of the image sensor 30 are non-linear with respect to the intensities. This non-linear characteristic shows after the threshold intensity. More specifically, below the threshold intensity, i.e., in the interval A, the output values of the image sensor 30 are linear and substantially similar to those obtained when the optical limiter 20 is not formed on the upper portion of the image pickup surface of the image sensor 30.

However, above the threshold intensity, i.e., in the interval B the output values of the image sensor 30 are non-linear in contrast with those obtained when the optical limiter 20 is not formed on the upper portion of the image pickup surface of the image sensor 30. In the interval having non-linear output values, the rate of increase in the output values with respect to the intensity is relatively small compared to that of the linear output values.

Therefore, the intensity I_{OL} having a saturated output value on the graph II where the optical limiter 20 is used is greater than the intensity I_{CCD} having a saturated output value on the graph I where the optical limiter 20 is not used. However, if the optical limiter 20 is used as in graph II, the output values of the image sensor 30 at higher intensities than I_{CCD} are not necessarily equal to the output value of I_{CCD}, but smaller than the output value of I_{CCD}.

Therefore, the output values of the image sensor 30 increase non-linearly from the intensity I_{CCD} (i.e., the intensity of a saturated output value in the case when the optical limiter 20 is not used). Additionally, the output value at the intensity I_{OL} (i.e., the intensity of a saturated output value in the case when the optical limiter 20 is used) becomes equal to the output value of the saturated intensity I_{CCD} (i.e., the intensity when the optical limiter 20 is not used, please refer to the graph I). An output value of the image sensor 30 can be obtained from the Equation below.
f_{CCD}(I_{CCD})=f_{CCD}(I_{OL})=Iₛₐₜ [Equation 2]
f_{OL-CCD}(I_{CCD})<f_{OL-CCD}(I_{OL})=Iₛₐₜ [Equation 3]
where f_{CCD} in Equation 2 indicates an output characteristic when the optical limiter 20 is not used, and f_{OL-CCD} in Equation 3 indicates an output characteristic when the optical limiter 20 is used.

As Equation 2 shows, if the optical limiter 20 is not used, the output values (i.e., the saturated output values) at I_{CCD} and I_{OL} are equal to the output value at Iₛₐₜ. However, as Equation 3 shows, if the optical limiter 20 is used, the output value (i.e., the saturated output value when not using optical limiter) at I_{CCD} is smaller than the output value at I_{OL} (i.e., a the saturated output value when using optical limiter). Although the output value at I_{OL} equals to the output value at I_{CCD} when the optical limiter 20 is not used, the output value at I_{OL} is smaller than the output value at I_{CCD}, meaning it is not yet saturated.

Therefore, by using the optical limiter 20 in interval D, where interval D ranges from the intensity I_{CCD} (i.e., the saturated output value when the optical limiter 10 is not used) to the intensity I_{OL} (i.e., the saturated value when the optical limiter used 20), the output values of the image sensor 30 become diversified.

By diversifying the output values of the image sensor 30 with respect to the intensities in the interval D, it becomes possible to display an image with different levels of brightness even at intensities in the interval D. Namely, the dynamic range (i.e., the index, indicating the range between the minimum optical signal and the maximum optical signal that can be treated) of the image sensing device 100 is expanded.

At this time, the non-linear characteristic interval where the rate of change in output values with respect to the input intensity decreases must include the intensity I_{CCD} having a saturated output value (i.e., the value where the image sensing device 100 without the optical limiter 20 causes saturation of the intensity). That is, the non-linear characteristic should appear from a lower intensity level than the I_{CCD} having a saturated output value when the optical limiter 20 is not used. This is so because, if the optical limiter 20 is used, the output value of the I_{CCD} is smaller than the output value of the Iₛₐₜ only if the intensity at the start point of the interval B showing the non-linear characteristic is smaller than the I_{CCD}. As such, the saturation occurs at the I_{OL}, which is greater than the I_{CCD}, resulting in the expansion of the dynamic range of the image sensing device.

Meanwhile, the expansion rate of the dynamic range of the image sensing device 100 can be obtained by Equation 4 below.

$$DR = \frac{{I}_{OL} - {I}_{CCD}}{{I}_{OL}} \qquad [ Equation 4 ]$$

wherein, DR is an expansion rate of the dynamic range; I_{CCD} is an intensity having a saturated value when the optical limiter 20 is not used; and I_{OL} is an intensity having a saturated value when the optical limiter 20 is used.

Accordingly, the optical limiter formed on the image pickup surface of the image sensor outputs a non-linear image with respect to the intensity of the input light, thereby expanding the dynamic range of the image sensing device.

By expanding the dynamic range of the image sensing device using the optical limiter made of materials having a non-linear characteristic with respect to the intensity of light, it becomes much easier to expand the dynamic range of the image sensing device without a separate device.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An image sensing device, comprising:
an optical limiter that converts an input image into a non-linear image at an intensity greater than a threshold intensity; and
an image sensor that converts the non-linear input image into an electrical signal.

2. The device according to claim 1, wherein the image sensor comprises:
a micro lens that condenses an input light;
a color filter that extracts a color signal from a plurality of signals inputted from the micro lens; and
a substrate that converts the extracted color signal into the electrical signal.

3. The device according to claim 1, wherein the optical limiter is formed at a threshold distance from an image pickup surface of the image sensor.

4. The device according to claim 1, wherein the optical limiter is deposited on an upper portion of an image pickup surface of the image sensor.

5. The device according to claim 1, wherein the image sensor is one of a CCD (Charge Coupled Device) and a CMOS (Complementary Metal Oxide Semiconductor).

6. The device according to claim 1, wherein the threshold intensity is smaller than a saturated output intensity of the image sensor without the optical limiter.

7. An image pickup apparatus using an image sensing device, the apparatus comprising:
an optical limiter that converts and outputs an input image into a non-linear image at an intensity greater than a threshold intensity;
an image sensor that photoelectrically converts the image output by the optical limiter;
a converter that converts and outputs the image from the image sensor into a digital signal; and
a signal processor that performs signal processing to display the input image output by the converter.

8. The apparatus according to claim 7, wherein the image sensor comprises:
a micro lens that condenses an input light;
a color filter that extracts a color signal from a plurality of signals inputted from the micro lens; and
a substrate that converts the extracted color signal into the electrical signal.

9. The apparatus according to claim 7, wherein the optical limiter is formed at a threshold distance from an image pickup surface of the image sensor.

10. The apparatus according to claim 7, wherein the optical limiter is deposited on an upper portion of an image pickup surface of the image sensor.

11. The apparatus according to claim 7, wherein the image sensor is one of a CCD (Charge Coupled Device) and a CMOS (Complementary Metal Oxide Semiconductor).

12. The apparatus according to claim 7, wherein the threshold intensity is smaller than a saturated output intensity of the image sensor without the optical limiter.

13. An image sensing device comprising:
means for converting an input image into a non-linear image at an intensity greater than a threshold intensity; and
means for converting the non-linear input image into an electrical signal.

14. The device according to claim 13, wherein the means for converting the non-linear input image comprises:
means for condensing an input light;
means for extracting a color signal from a plurality of signals inputted from the means for condensing; and
means for converting the extracted color signal into the electrical signal.

15. The device according to claim 13, wherein the means for converting the input image is formed at a threshold distance from an image pickup surface of the means for converting the non-linear input image.

16. The device according to claim 13, wherein the means for converting the input image is deposited on an upper portion of an image pickup surface of means for converting the non-linear input image.

17. The device according to claim 13, wherein the means for converting the non-linear input image is one of a CCD (Charge Coupled Device) and a CMOS (Complementary Metal Oxide Semiconductor).
